(19) United States
(12) Patent Application Publication
(10) Pub. No.: US 2024/0330957 A1
(43) Pub. Date: Oct. 3, 2024

(54) METHOD OF CALCULATING CARBON CREDIT BASED ON PERSONAL CARBON EMISSION

(71) Applicant: NATIONAL CHUNG HSING UNIVERSITY, TAICHUNG CITY (TW)

(72) Inventors: Kuan-Jiuh LIN, TAICHUNG CITY (TW); Jun-Wei SU, TAICHUNG CITY (TW)

(21) Appl. No.: 18/735,193

(22) Filed: Jun. 6, 2024

Related U.S. Application Data
(63) Continuation-in-part of application No. 17/720,747, filed on Apr. 14, 2022.

(30) Foreign Application Priority Data
Apr. 16, 2021 (TW) 110113694

(51) Int. Cl. G06Q 30/018; G01C 21/34

(52) U.S. Cl. CPC G06Q 30/018; G01C 21/3469

(57) ABSTRACT

A method of calculating carbon credit based on personal carbon emission is provided for a user activating a portable device to execute, upon passing through each predetermined node of a predetermined route, a traveling means data and a travel distance toward a next predetermined node, in order to calculate a segmental personal carbon emission amount. When reaching the last predetermined node, the portable device adds up all of the segmental personal carbon emission amounts to obtain a one-trip personal carbon emission amount. The portable device subjects the one-trip personal carbon emission amounts corresponding to an average carbon emission amount to averaging with the one-trip personal carbon emission amount of this round to update as a new average carbon emission amount. The new average carbon emission amount so updated serves as a calculation basis of carbon credit for the next round of taking the predetermined route.

### CROSS REFERENCE TO RELATED APPLICATIONS

This is a continuation-in-part of co-pending U.S. patent application Ser. No. 17/720,747 filed on Apr. 14, 2022, which claims priority to Taiwanese Invention patent Application No. 110113694, filed on Apr. 16, 2021.

### BACKGROUND OF THE INVENTION

### (a) Technical Field of the Invention

The present invention relates to the technical field of statistical management of carbon emission, and more particularly to a method of calculating a carbon credit based on personal carbon emission.

### (b) Description of the Prior Art

In order to reduce global warming, many countries have signed several important treaties, such as Kyoto Protocol, Paris Agreement, etc., to limit the total global greenhouse gas emissions, in an attempt to reduce the impact of greenhouse gases on the increase in global average temperature. In some countries, carbon dioxide is the largest among the greenhouse gas emissions.

For developed countries, the cost and difficulty of reducing existing carbon emissions are quite high, so the United Nations approved a carbon emission trading system that makes the right to emit carbon dioxide (referred to as a carbon credit) a commodity for trade. In this way, companies or countries can buy carbon credits from another party to obtain greenhouse gas emission reductions.

A conventional approach of calculating a carbon credit is to provide a carbon emission statistical method and have this method be approved in the first year, then to collect carbon emission data for a whole year in the second year, and after a carbon emission baseline has been verified based on the carbon emission data in the second year, to collect carbon emission data for a whole year in the third year, and to compare the carbon emission data in the third year with the carbon emission baseline to obtain the carbon credit. Only when a carbon emission amount in the third year is smaller than the carbon emission baseline does the carbon credit have a positive value.

Accordingly, the conventional approach is time consuming and costly. Usually only large companies have the budget and capacity to implement such approach.

According to the International Transport Forum 2010, transportation is second only to electricity generation in terms of carbon emissions, accounting for 24% of total emissions. However, it is difficult for ordinary people to implement the conventional approach of calculating a carbon credit for their daily commute. Moreover, the route that people take daily to move may change because of job transfer, school transfer or moving house, and it is not easy to maintain the same route of moving proposed in the first year for the second and third years, and as such, carbon credits might not be effectively utilized.

Further, existing personal carbon credit calculating methods commonly take comparison of a personal carbon emission amount with a standard carbon emission baseline available from public average carbon emission. For people using transport schemes of high carbon emissions, regardless how and what actions they are taking, the carbon credits obtained are always of negative values and it is virtually of no positive value, resulting in no motivation for the people to take any carbon reduction movement. As such, it is indeed necessary to further improve the existing carbon credit calculating methods.

In brief, the existing carbon credit calculating methods are imperfect and suffer problems of extended long time period for establishing carbon emission baseline and not in line with human nature. leading to inconvenience and trouble in calculating personal carbon credit. Thus, it is a challenge of the related businesses and the public to develop further improvements to alleviate such problems, and this is also what the present invention intends to discuss.

### SUMMARY OF THE INVENTION

Thus, the primary objective of the present invention is to provide a method of calculating carbon credit based on personal carbon emission that can shorten the time it takes to establish a baseline for carbon emissions.

Further, another objective of the present invention is to provide a method of calculating carbon credit based on personal carbon emission that selects a comparison baseline according to the carbon emission of a personal carbon emission transport scheme to provide people using both high and low carbon emission transport schemes a chance to obtain a positive carbon credit for encouraging and keeping the motivation for consistent carbon reduction to effectively achieve the purpose of carbon reduction.

Based on this, the present invention mainly adopts the following technical solution to realize the above objectives and advantages. The present invention provides a method for calculating carbon credit based on personal carbon emission for a user using a portable device to calculate carbon credit saved in each round of traveling along a predetermined route, wherein the predetermined route comprises a plurality of predetermined nodes, and a route between two adjacent ones of the predetermined nodes is defined as a travel segment, wherein the portable device comprises a display panel for displaying data, a satellite positioning module for measuring a self-position, a storage module for storing data, and an operation module electrically connected with the display panel, the satellite positioning module, and the storage module, the method of calculating carbon credit based on personal carbon emission comprising the following steps:
Step S1, the user activating the portable device and starting to move along the predetermined route, such that the portable device is operable to identify predetermined nodes past thereby, to define the travel segments, and to calculate a travel distance and a carbon credit saved, wherein the storage module stores at least one predetermined traveling means carbon emission parameter corresponding to a plurality of types of traveling means data, an average carbon emission amount and every one-trip personal carbon emission amount corresponding thereto, a cumulative comparison carbon credit, and a cumulative standard carbon credit;
Step S2, passing through one of the predetermined nodes and executing at least one round of segmental carbon emission calculation operation, wherein upon passing through one of predetermined nodes, the portable device starts to perform at least one round of segmental carbon emission calculation operation, wherein each round of segmental carbon emission calculation operation comprises:
Step S2-1, executing a traveling means data and recording a travel distance toward a next one of the predetermined nodes, wherein a traveling means data is selected and executed, and the portable device calculates the travel distance toward the next one of the predetermined nodes based on measurement data of the satellite positioning module; and
Step S2-2, calculating a segmental personal carbon emission amount corresponding to the travel segment, wherein the operation module applies Formula (1) to calculate a segmental personal carbon emission amount of the user corresponding to the travel segment for storing in the storage module,

$$\\ \begin{matrix}{PA}_{( N )} = {V}_{( X )} * {D}_{( N )} & Formula ( 1 )\end{matrix}$$

where PA is the segmental personal carbon emission amount of the user; V_{(X)} is the traveling means carbon emission parameter of the traveling means so selected; and D_{(N)} is a total travel distance within the travel segment;
Step S3, adding up all segmental personal carbon emission amounts to obtain a one-trip personal carbon emission amount corresponding to the predetermined route, wherein when the portable device reaches a last one of the predetermined nodes of the predetermined route, Formula (4) is applied to carry out calculation by adding up all of the segmental personal carbon emission amounts that are calculated in Step S2-2 of each round performed for the predetermined route to calculate a one-trip personal carbon emission amount corresponding to the predetermined route and Formula (4-1) is applied to calculate an average carbon emission amount of the user for storing in the storage module,

$$\\ \begin{matrix}TPA = {PA}_{( 1 )} + {PA}_{( 2 )} + … + {PA}_{( N )} & Formula ( 4 )\end{matrix}$$

$$\\ \begin{matrix}ACE = {TPA}_{( 1 )} + {TPA}_{( 2 )} + … + {TPA}_{( N - 1 )} / N - 1 & Formula ( 4 ‐ 1 )\end{matrix}$$

where TPA is the one-trip personal carbon emission amount of the entire trip, and ACE is the average carbon emission amount of the entire trip;
Step S4, calculating a one-trip carbon emission comparison amount based on the average carbon emission amount and the one-trip personal carbon emission amount, and adding the one-trip carbon emission comparison amount to a cumulative comparison carbon credit to serve as a new cumulative comparison carbon credit to be displayed on the portable device, wherein Formula (5) or Formula (6) is applied to calculate the one-trip carbon emission comparison amount based on the average carbon emission amount and the one-trip personal carbon emission amount stored in the storage module, and Formula (7) and Formula (7-1) are applied to calculate the new cumulative comparison carbon credit that is then displayed on the portable device; and

$$\\ \begin{matrix}when ACE > TPA , CTA = ACE - TPA & Formula ( 5 )\end{matrix}$$

$$\\ \begin{matrix}when ACE \leq TPA , CTA = 0 or = ACE - TPA & Formula ( 6 )\end{matrix}$$

$$\\ \begin{matrix}and ACC = SUM ( {CTA}_{( 1 )} : {CTA}_{( N )} ) & Formula ( 7 )\end{matrix}$$

$$\\ \begin{matrix}NACC = SUM [ {( CTA + ACC )}_{( 1 )} : {( CTA + ACC )}_{( N )} ] & Formula ( 7 ‐ 1 )\end{matrix}$$

where ACE is the average carbon emission amount; TPA is the one-trip personal carbon emission amount; CTA is the one-trip carbon emission comparison amount; ACC is the cumulative comparison carbon credit; and NACC is the new cumulative comparison carbon credit;
Step S5, subjecting the average carbon emission amount and all of the one-trip personal carbon emission amounts corresponding thereof to an averaging operation with the one-trip personal carbon emission amount of this round to update to a new average carbon emission amount, wherein the portable device subjects the average carbon emission amount and all of the one-trip personal carbon emission amounts corresponding thereto to operation of Formula (8) to update to a new average carbon emission amount to be stored in the storage module,

$$\\ \begin{matrix}NACE = SUM ( {TPA}_{( 1 )} : {TPA}_{( N )} ) / N & Formula ( 8 )\end{matrix}$$

where NACE is the new average carbon emission amount.

The efficacy of the present invention is that the portable device is used to calculate the one-trip personal carbon emission amount for each round the user takes the predetermined route, and to calculate a new average carbon emission amount to serve as a calculation basis for the next round of taking the predetermined route. Therefore, it does not take years to establish a carbon emission baseline, which can effectively shorten the time to establish the carbon emission baseline, and also, implementing with the present invention is more in line with human nature and can effectively encourage people using both high and low carbon emission transport schemes to consistently carry out movement for carbon reduction in order to further lower down the amount of carbon emission, thereby greatly enhancing the practicability and realizing the economic values.

For better understanding of the constitution, features, and other objectives of the present invention. preferred embodiments of the present invention are illustrated below. with reference to the attached drawings, in order to allow for implementation thereof by those skilled in the technical field.

### BRIEF DESCRIPTION OF THE DRAWINGS

FIG. 1 is a system block diagram illustrating a portable device of a method of calculating carbon credit based on personal carbon emission according to an embodiment of the present invention;

FIG. 2 is a flow chart of the embodiment; and

FIG. 3 is a schematic diagram illustrating an example of carbon emissions of three transport schemes for traveling along a predetermined route.

### DETAILED DESCRIPTION OF THE PREFERRED EMBODIMENTS

The present invention relates to a method of calculating carbon credit based on personal carbon emission. In specific embodiments illustrated om the accompanying drawings, and the components thereof, all references to description related to front and rear, left and right, top and bottom, upper and lower, and horizontal and vertical are adopted for easy description, but not intended to limit the present invention, nor do constrain the components thereof in any location or spatial direction. The sizes designated in the drawings and the disclosure may be changed, without departing the scope of the claims of the invention, by complying with the design and requirement of the present invention.

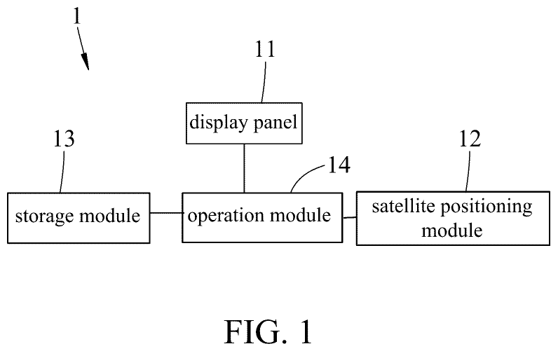

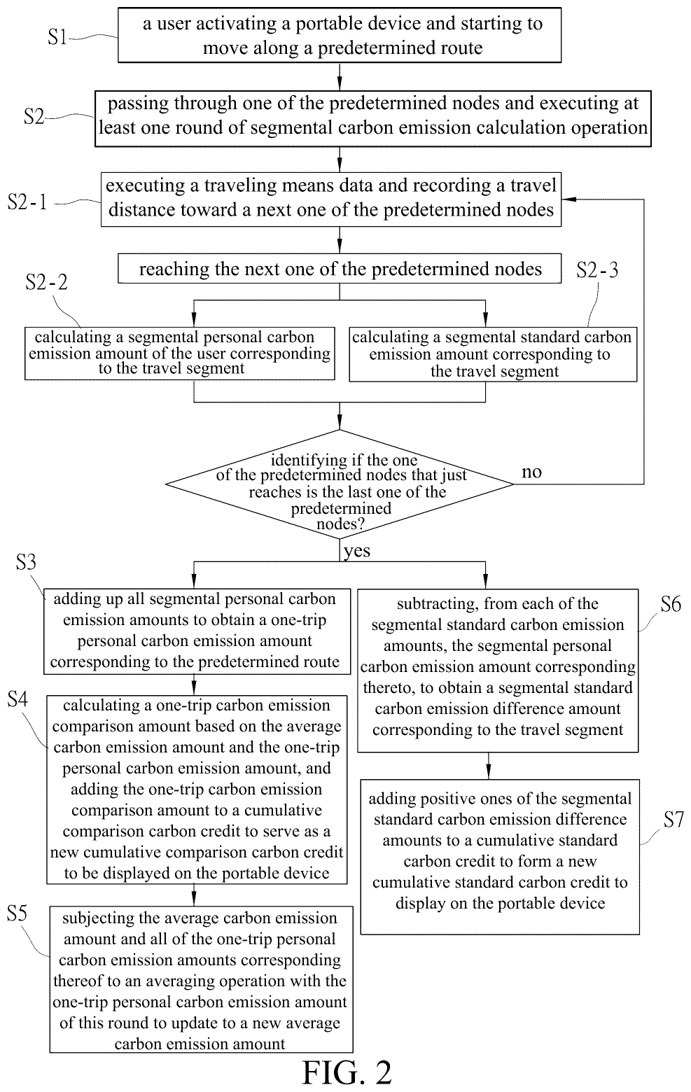

Referring to FIGS. 1 and 2, a method of calculating carbon credit based on personal carbon emission according to an embodiment of the present invention is provided for calculating an amount of carbon credit C saved for each round a user traveling along a predetermined route T. The predetermined route comprises a plurality of predetermined nodes P. A route between two adjacent ones of the predetermined nodes is defined as a travel segment R.

The method of calculating carbon credit based on personal carbon emission comprises the following Steps S1-S7.
Step S1: a user activating a portable device and starting to move along a predetermined route, wherein the portable device 1 comprises a display panel 11 that displays programs and data, a satellite positioning module 12 that measures a self-position, a storage module 13, and an operation module 14 that is electrically connected with the display panel 11, the satellite positioning module 12, and the storage module 13; the storage module 13 stores at least one predetermined traveling means carbon emission parameter V_{(X)} corresponding to a plurality of types of traveling means data, an average carbon emission amount ACE and every one-trip personal carbon emission amount TPA corresponding thereto, a cumulative comparison carbon credit ACC, and a cumulative standard carbon credit Z, and is displayable on the display panel 11 of the portable device 1; and in the instant embodiment, the display panel 11 of the portable device 1 may be a smart phone screen, a smart watch scree, or a screen of other portable display devices.
Step S2: passing through one of the predetermined nodes and executing at least one round of segmental carbon emission calculation operation, wherein upon passing through one of predetermined nodes P, the portable device 1 starts to perform at least one round of segmental carbon emission calculation operation, wherein each round of segmental carbon emission calculation operation comprises the following Steps S2-1, S2-2, and S2-3.
Step S2-1: executing a traveling means data and recording a travel distance toward a next one of the predetermined nodes, wherein a traveling means data is selected and executed, and also, a travel distance D toward a next one of the predetermined nodes is recorded, wherein the operation module 14 of the portable device 1 calculates the travel distance D based on measurement data of the satellite positioning module 12.
Step S2-2: calculating a segmental personal carbon emission amount corresponding to the travel segment, wherein when the portable device 1 reaches said next one of the predetermined nodes, the operation module 14 calculating a segmental personal carbon emission amount PA of the user corresponding to the travel segment R, and stores the segmental personal carbon emission amount PA in the storage module 13, wherein the segmental personal carbon emission amount PA is a product of a predetermined traveling means carbon emission parameter V_{(X)} corresponding to the traveling means data and a total travel distance D_{(N)} within the travel segment, see Formula (1) below:

$${PA}_{( N )} = {V}_{( X )} * {D}_{( N )} \qquad ( 1 )$$

where PA is the segmental personal carbon emission amount of the user; V_{(X)} is the traveling means carbon emission parameter of the traveling means so selected; and D_{(N)} is the total travel distance within the travel segment.
Step S2-3: calculating a segmental standard carbon emission amount corresponding to the travel segment, wherein the portable device 1 calculates a segmental standard carbon emission amount corresponding to the travel segment, wherein the segmental standard carbon emission amount SA is a product of a lowest one V_{(X)L} of the predetermined traveling means carbon emission parameters corresponding to the plurality of traveling means data in the travel segment and a total of the travel distance D_{(N)} within the travel segment R, see Formula (2) below:

$$S {A}_{( N )} = {V}_{( X ) L} * {D}_{( N )} \qquad ( 2 )$$

$$TSA = {SA}_{( 1 )} + S {A}_{( 2 )} + … + S {A}_{( N} \qquad ( 3 )$$

where SA is the segmental standard carbon emission amount; V_{(X)L} is the lowest traveling means carbon emission parameter among the predetermined traveling means; D_{(N)} is the travel distance; and TSA is the one-trip standard carbon emission amount of the entire trip.

For example, in case that in a given travel segment, there are a bus route and a train/rapid transit route (where one node and the next node are respectively a starting station and a destination station of the public transport), the lowest one of the carbon emissions of the bus and the train/rapid transit is taken as a basis for calculating the segmental standard emission amount; and in case that there is no bus, train, or rapid transit route available in the travel segment, a motorcycle is taken for calculating the segmental standard emission amount.
Step S3: adding up all segmental personal carbon emission amounts to obtain a one-trip personal carbon emission amount corresponding to the predetermined route, wherein when the portable device 1 reaches a last one of the predetermined nodes of the predetermined route, the operation module 14 adds up all of the segmental personal carbon emission amounts PA_{(N)} (see Formula (1)) that are calculated in Step S2-2 of each round performed for the predetermined route to obtain a one-trip personal carbon emission amount TPA corresponding to the predetermined route and stored in the storage module 13, see Formula (4) below:

$$TPA = {PA}_{( 1 )} + P {A}_{( 2 )} + … + P {A}_{( N )} \qquad ( 4 )$$

$$ACE = {TPA}_{( 1 )} + T P {A}_{( 2 )} + … + T P {A}_{( N - 1 )} / N - 1 \qquad ( 4 - 1 )$$

where TPA is the one-trip personal carbon emission amount of the entire trip, and ACE is the average carbon emission amount of the entire trip.
Step S4: calculating a one-trip carbon emission comparison amount based on the average carbon emission amount and the one-trip personal carbon emission amount, and adding the one-trip carbon emission comparison amount to a cumulative comparison carbon credit to serve as a new cumulative comparison carbon credit to be displayed on the portable device, wherein the operation module 14 of the portable device 1 is operated to calculate the one-trip carbon emission comparison amount CTA based on the average carbon emission amount ACE stored in the storage module 13 and the one-trip personal carbon emission amount TPA, and then adds the one-trip carbon emission comparison amount CTA to a cumulative comparison carbon credit ACC to produce a new cumulative comparison carbon credit NACC that is then displayed on the portable device 1.

In the instant embodiment, the calculation of the one-trip carbon emission comparison amount CTA is that in case that the average carbon emission amount ACE is greater than the one-trip personal carbon emission amount TPA, the one-trip carbon emission comparison amount CTA is obtained by subtracting the one-trip personal carbon emission amount TPA from the average carbon emission amount ACE, and in case that the average carbon emission amount ACE is less than or equal to the one-trip personal carbon emission amount TPA, the one-trip carbon emission comparison amount CTA is set to zero; however, in other embodiments, the calculation of the one-trip carbon emission comparison amount CTA can be such that subtracting the one-trip personal carbon emission amount TPA from the average carbon emission amount ACE to calculate the one-trip carbon emission comparison amount CTA, see Formulas (5), (6), (7), and (7-1) below:

$$When ACE > TPA , CTA = ACE - TPA \qquad ( 5 )$$

$$When ACE \leq TPA , CTA = 0 or = ACE - TPA \qquad ( 6 )$$

$$and ACC = SUM ( {CTA}_{( 1 )} : CT {A}_{( N )} ) \qquad ( 7 )$$

$$NACC = SUM [ {( CTA + A C C )}_{( 1 )} : {( CTA + ACC )}_{( N )} ] \qquad ( 7 - 1 )$$

where ACE is the average carbon emission amount; TPA is the one-trip personal carbon emission amount; CTA is the one-trip carbon emission comparison amount; ACC is the cumulative comparison carbon credit; and NACC is the new cumulative comparison carbon credit.
Step S5: subjecting the average carbon emission amount and all of the one-trip personal carbon emission amounts corresponding thereof to an averaging operation with the one-trip personal carbon emission amount of this round to update to a new average carbon emission amount, wherein the portable device 1 subjects the average carbon emission amount ACE and all of the one-trip personal carbon emission amounts TPA corresponding thereto, and the one-trip personal carbon emission amount TPA_{(N)} of this round to an averaging operation to update to a new average carbon emission amount NACE to be stored in the storage module 13, see Formula (8) below:

$$NACE = SUM ( {TPA}_{( 1 )} : TP {A}_{( N )} ) / N \qquad ( 8 )$$

where NACE is the new average carbon emission amount.
Step S6: subtracting, from each of the segmental standard carbon emission amounts, the segmental personal carbon emission amount corresponding thereto, to obtain a segmental standard carbon emission difference amount corresponding to the travel segment, wherein when the portable device 1 of the user reaches the last one of the predetermined nodes of the predetermined route, for each of the segmental standard carbon emission amounts SA_{(N)} calculated in Step S2-3 of each round, the segmental personal carbon emission amount PA_{(N)} corresponding thereto is subtracted to obtain a segmental standard carbon emission difference amount SAD_{(N)} corresponding to the travel segment R, see Formula (9) below:

$$S A {D}_{( N )} = S {A}_{( N )} - {PA}_{( N )} \qquad ( 9 )$$

where SAD_{(N)} is the segmental standard carbon emission difference amount; SA_{(N)} is the segmental standard carbon emission amount (see Formula (2)); and PA_{(N)} is the segmental personal carbon emission amount (see Formula (1)).
Step S7: adding positive ones of the segmental standard carbon emission difference amounts to a cumulative standard carbon credit to form a new cumulative standard carbon credit to display on the portable device, wherein the positive ones of the segmental standard carbon emission difference amounts SAD_{(N)} of the portable device 1 and a cumulative standard carbon credit Z stored in the storage module 13 are added together to produce a new cumulative standard carbon credit NZ that is then displayed on the portable device 1, and stores the new cumulative standard carbon credit NZ again in the storage module 13 to serve as a next cumulative standard carbon credit Z, see Formula (10) below:

$$When {SAD}_{( N )} > 0 , N Z = S A {D}_{( N )} + Z \qquad ( 10 )$$

where NZ is the new cumulative standard carbon credit, and Z is the cumulative standard carbon credit.

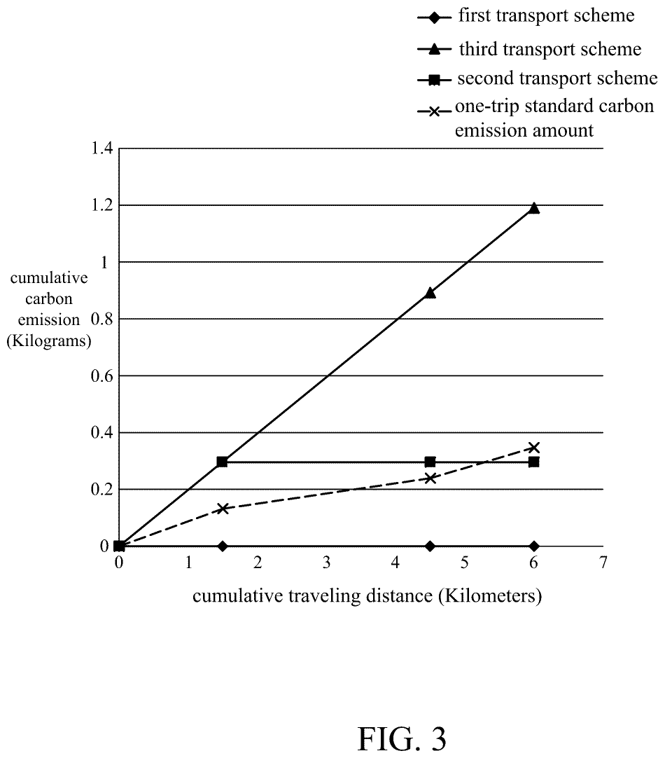

Referring to the following Tables 1-4 and FIG. 3, a predetermined route having a total length of 6 kilometers is taken as an example for illustrating a flow of calculation of the method of calculating carbon credit based on personal carbon emission. In the instant embodiment, the predetermined route is a commute route. A commute route is highly repetitive and consistent and may provide advantages and practicability for carbon credit certification. The predetermined route is made up of three travel distances, which are respectively D₁ of 1.5 kilometers, D₂ of 3 kilometers, and D₃ of 1.5 kilometers defining travel segments R₁, R₂, R₃, respectively.

In a first transport scheme, the traveling means adopted in the three travel segments are respectively walking for R₁, bicycle for R₂, and bicycle for R₃, and accordingly, the average carbon emission amount TPA for the predetermined route is 0 kilograms.

In a second transport scheme, the traveling means adopted in the three travel segments are respectively passenger car for R₁, bicycle for R₂, and bicycle for R₃, and accordingly, the average carbon emission amount TPA for the predetermined route is 0.297 kilograms.

In a third transport scheme, the traveling means adopted in the three travel segments are passenger cars for all R₁-R₃, and accordingly, the average carbon emission amount TPA for the predetermined route is 1.19 kilograms.

Calculation of standard carbon emission for the predetermined route is carried out by taking no bus route available for 0-1.5 kilometer and 4.5-6 kilometer and a bus route available for 1.5-4.5 kilometers as an example, and as such, the calculation is made by taking a motorcycle as the traveling means for 0-1.5 kilometer, a bus for the traveling means for 1.5-4.5, and a motorcycle for the traveling means for 4.5-6, and the carbon emission for 1.5-4.5 kilometer is calculated on the basis of dividing the carbon emission of a bus by the average passengers of the bus, which are 20 persons. Accordingly, a sum of the three segmental standard carbon emission amounts of the predetermined route is 0.37 kilograms.

TABLE 1
carbon emissions in the predetermined route for three commute schemes

| Predetermined | | | | | |
|---|---|---|---|---|---|
| route (kilometers) | | 0-1.5 | 1.5-4.5 | 4.5-6 | Sum |
| First | Traveling | “On foot” | Bicycle | Bicycle | |
| transport | Means | | | | |
| scheme | Carbon | 0 | 0 | 0 | 0 |
| | emission | | | | |
| | (kilograms) | | | | |
| Second | Traveling | Car | Bicycle | Bicycle | |
| transport | Means | | | | |
| scheme | Carbon | 0.297 | 0 | 0 | 0.297 |
| | emission | | | | |
| | (kilograms) | | | | |
| Third | Traveling | Car | Car | Car | |
| commute | Means | | | | |
| scheme | Carbon | 0.297 | 0.595 | 0.297 | 1.19 |
| | emission | | | | |
| | (kilograms) | | | | |
| Standard | Traveling | Motorcycle | Bus | Motorcycle | |
| carbon | Means | | | | |
| emission | Carbon | 0.131 | 0.108 | 0.131 | 0.37 |
| | emission | | | | |
| | (kilograms) | | | | |

It is particularly noted here that the above-discussed carbon emission coefficients of the passenger car, but, and motorcycle are calculated according to the carbon emission coefficients of fuel vehicles. If an actually used traveling means in an application is an electric vehicle, then the carbon emission coefficients must be calculated according to the carbon emission coefficients of electric vehicles, and the calculation can be done on the basis of electric vehicle carbon emission coefficients published by a government agency, or the calculation can be made on the basis of electricity consumed per kilometer by electric vehicle and the carbon emission coefficient for electrical power consumption published by a government agency.

Referring to Table 2, in a five-day example, in which the third transport scheme is adopted for the first four days and the first transport scheme is adopted for the last day, the cumulative comparison carbon credit of the fifth day is 1.19, while the cumulative standard carbon credit is only 0.37, and this is because that the user selects, for the first four days, the third transport scheme that has high carbon emission, and thus, compared to the average carbon emission amounts of the first four days, the amount of carbon emission reduced at the fifth day is significant. Using only the cumulative standard carbon credit of 0.37 as the amount of carbon emission saved would underestimate an actual amount of carbon emission saved. Therefore, in this case, the cumulative comparison carbon credit of 1.19 is more representative of the actual amount of carbon emission saved. In this way, the user may be motivated to switch his/her habitual transport scheme to instead select a transport scheme of lower carbon emissions so as to obtain an even higher cumulative comparison carbon credit.

TABLE 2
Example 1 for cumulative comparison carbon
credit and cumulative standard carbon credit

| | First | Second | Third | Fourth | Fifth |
|---|---|---|---|---|---|
| Day | day | day | day | day | day |
| Transport | Third | Third | Third | Third | First |
| scheme | Transport | Transport | Transport | Transport | Transport |
| | scheme | scheme | scheme | scheme | scheme |
| One-trip personal | 1.19 | 1.19 | 1.19 | 1.19 | 0 |
| carbon emission | | | | | |
| amount (TPA) | | | | | |
| Average carbon | NA | 1.19 | 1.19 | 1.19 | 1.19 |
| emission | | | | | |
| amount (ACE) | | | | | |
| One-trip carbon | 0 | 0 | 0 | 0 | 1.19 |
| emission | | | | | |
| comparison | | | | | |
| amount (CTA) | | | | | |
| Cumulative | 0 | 0 | 0 | 0 | 1.19 |
| comparison | | | | | |
| carbon credit | | | | | |
| (ACC) | | | | | |
| new average | 1.19 | 1.19 | 1.19 | 1.19 | 0.952 |
| carbon emission | | | | | |
| average amount | | | | | |
| (NACE) | | | | | |
| Segmental | −0.166 | −0.166 | −0.166 | −0.166 | 0.131 |
| standard | | | | | |
| emission | | | | | |
| difference (SAD) | | | | | |
| amount for | | | | | |
| 0-1.5 km | | | | | |
| Segmental | −0.487 | −0.487 | −0.487 | −0.487 | 0.108 |
| standard carbon | | | | | |
| emission | | | | | |
| difference | | | | | |
| amount (SAD) | | | | | |
| for 1.5-4.5 km | | | | | |
| Segmental | −0.166 | −0.166 | −0.166 | −0.166 | 0.131 |
| emission | | | | | |
| difference amount | | | | | |
| for 4.5-6 km | | | | | |
| Cumulative | 0 | 0 | 0 | 0 | 0.37 |
| standard | | | | | |
| difference | | | | | |
| carbon credit (Z) | | | | | |

Note:
only positive ones of the segmental standard carbon emission difference amounts are counted for the cumulative standard carbon credit

Referring to Table 3, in case that the first transport scheme is adopted for all of the five days, since the one-trip personal carbon emission amount of each day is zero, the cumulative comparison carbon credit is also zero. However, as the transport scheme selected by the user is lower than each segmental standard carbon emission amount, in this case, the cumulative standard carbon credit 1.85 is more representative of the actual amount of carbon emission saved. In this way, the user is motivated to build a long-term habit of adopting a transport scheme having carbon emission lower than the segmental standard emission amounts so as to obtain a higher cumulative standard carbon credit.

TABLE 3
Example 2 for cumulative comparison carbon
credit and cumulative standard carbon credit

| | First | Second | Third | Fourth | Fifth |
|---|---|---|---|---|---|
| Day | day | day | day | day | day |
| Transport | First | First | First | First | First |
| scheme | Transport | Transport | Transport | Transport | Transport |
| | scheme | scheme | scheme | scheme | scheme |
| One-trip | 0 | 0 | 0 | 0 | 0 |
| personal carbon | | | | | |
| emission amount | | | | | |
| (TPA) | | | | | |
| Average | NA | 0 | 0 | 0 | 0 |
| carbon emission | | | | | |
| amount (ACE) | | | | | |
| One-trip carbon | 0 | 0 | 0 | 0 | 0 |
| emission | | | | | |
| comparison | | | | | |
| amount (CTA) | | | | | |
| Cumulative | 0 | 0 | 0 | 0 | 0 |
| comparison | | | | | |
| carbon credit | | | | | |
| (ACC) | | | | | |
| New avergae | 0 | 0 | 0 | 0 | 0 |
| carbon | | | | | |
| emission | | | | | |
| amount (NACE) | | | | | |
| Segmental | 0.131 | 0.131 | 0.131 | 0.131 | 0.131 |
| standard carbon | | | | | |
| emission | | | | | |
| difference (SAD) | | | | | |
| amount for | | | | | |
| 0-1.5 km | | | | | |
| Segmental | 0.108 | 0.108 | 0.108 | 0.108 | 0.108 |
| standard carbon | | | | | |
| emission | | | | | |
| difference | | | | | |
| amount (SAD) | | | | | |
| for 1.5-4.5 km | | | | | |
| Segmental | 0.131 | 0.131 | 0.131 | 0.131 | 0.131 |
| standard carbon | | | | | |
| emission | | | | | |
| difference | | | | | |
| amount (SAD) | | | | | |
| for 4.5-6 km | | | | | |
| Cumulative | 0.37 | 0.74 | 1.11 | 1.48 | 1.85 |
| standard | | | | | |
| carbon credit (Z) | | | | | |

Note:
only positive ones of the segmental standard carbon emission difference amounts are counted for the cumulative standard carbon credit

Referring to Table 4, in case that the second transport scheme, the second transport scheme, the first transport scheme, the third transport scheme, and the second transport scheme are respectively and sequentially adopted for the five days, considering the second day, as the second day adopts the same transport scheme as the first day, for the second day, the one-trip personal carbon emission amount and the average carbon emission amount (which is the one-trip personal carbon emission amount of the first day) are the same, and thus, the cumulative comparison carbon credit is zero; however, in comparison with the standard carbon emission, some of the segmental standard carbon emission difference amounts of the first and second days have positive values, meaning being lower than standard carbon emissions, and thus, the cumulative standard carbon credit reaches 0.478.

Considering the fourth day, as the one-trip personal carbon emission amount of the third transport scheme adopted in the fourth day is relatively high, the average carbon emission amount (0.198) is less than the one-trip personal carbon emission amount (1.19). Therefore, the one-trip carbon emission comparison amount is zero, and the cumulative comparison carbon credit is set at 0.297 to be the same as that of the third day. For the cumulative standard carbon credit, since each of the segmental standard carbon emission difference amounts for the third transport scheme adopted in the fourth day has a negative value, the cumulative standard carbon credit is the same as the cumulative standard carbon credit of the third day. In this way, the user may be motivated to take thought for the time and distance of each of the travel segments and select traveling means having lower carbon emission, so as to obtain higher cumulative comparison carbon credit and cumulative standard carbon credit.

TABLE 4
Example 3 for cumulative comparison carbon
credit and cumulative standard carbon credit

| | First | Second | Third | Fourth | Fifth |
|---|---|---|---|---|---|
| Day | day | day | day | day | day |
| Transport | Second | Second | First | Third | Second |
| scheme | commute | commute | commute | commute | commute |
| | scheme | scheme | scheme | scheme | scheme |
| One-trip personal | 0.297 | 0.297 | 0 | 1.19 | 0.297 |
| carbon emission | | | | | |
| amount (TPA) | | | | | |
| Average | NA | 0.297 | 0.297 | 0.198 | 0.446 |
| carbon emission | | | | | |
| amount (ACE) | | | | | |
| One-trip carbon | 0 | 0 | 0.297 | 0 | 0.149 |
| emission | | | | | |
| comparison | | | | | |
| amount (CTA) | | | | | |
| Cumulative | 0 | 0 | 0.297 | 0.297 | 0.446 |
| comparison | | | | | |
| carbon credit | | | | | |
| (ACC) | | | | | |
| New avergae | 0.297 | 0.297 | 0.198 | 0.446 | 0.4162 |
| carbon | | | | | |
| emission | | | | | |
| amount (NACE) | | | | | |
| Segmental | −0.166 | −0.166 | 0.131 | −0.166 | −0.166 |
| standard carbon | | | | | |
| emission | | | | | |
| difference | | | | | |
| amount (SAD) | | | | | |
| for 0-1.5 km | | | | | |
| Segmental | 0.108 | 0.108 | 0.108 | −0.487 | 0.108 |
| standard carbon | | | | | |
| emission | | | | | |
| difference | | | | | |
| amount (SAD) | | | | | |
| for 1.5-4.5 km | | | | | |
| Segmental | 0.131 | 0.131 | 0.131 | −0.166 | 0.131 |
| standard carbon | | | | | |
| emission | | | | | |
| difference | | | | | |
| amount (SAD) | | | | | |
| for 4.5-6 km | | | | | |
| Cumulative | 0.239 | 0.478 | 0.848 | 0.848 | 1.087 |
| standard | (=0 + | (=0.239 + | (=0.478 + | | (=0.848 + |
| carbon credit (Z) | 0.108 + | 0.108 + | 0.131 + | | 0.108 + |
| | 0.131) | 0.131) | 0.108 + | | 0.131) |
| | | | 0.131) | | |

Note:
only positive ones of the segmental standard carbon emission difference amounts are counted for the cumulative standard carbon credit

Accordingly, based on the description made above, advantages of the method of calculating carbon credit based on personal carbon emission are as follows:
(1) Since the user can utilize the portable device 1 to calculate the one-trip personal carbon emission amount for each round of taking the predetermined route, and to calculate a new average carbon emission amount, which serves as a basis for calculation in the next round of the predetermined route, it does not take years to establish a carbon emission baseline, which can effectively shorten the time to establish the carbon emission baseline.
(2) Following Point (1), by shortening the time it takes to establish a carbon emission baseline, users can easily accumulate the carbon credits from their daily commute, thus allowing for effective use of carbon credits.
(3) For users who often choose transport schemes of lower carbon emissions, the method of the present invention also calculates the cumulative standard carbon credit, which is based on the segmental standard carbon emission amounts, so as to avoid underestimation of carbon credits.
(4) Since the predetermined route may be a commute route, which is highly repetitive and consistent, it is a practical and worthwhile option for carbon credits calculation and certification.

It is noted that in other embodiments, the storage module 13 may store predetermined traveling means carbon emission parameters, which correspond respectively to different traveling speeds of each type of traveling means data, and in Step S2-1, the operation module 14 calculates an average traveling speed according to the measurement data of the satellite positioning module 12, and in Step S2-2, the operation module 14 uses the recorded traveling means data and the predetermined traveling means carbon emission parameter to which the average traveling speed corresponds to calculate the segmental personal carbon emission amount, and this achieves the same effectiveness.

Further, in other embodiments, it is also possible to use classification of roads along which the traveling is made and vehicle conditions as adjustment parameters of carbon-emission coefficients.

To sum up, the method of calculating carbon credit based on personal carbon emission according to the present invention uses the portable device 1 to calculate the one-trip personal carbon emission amount for each round the user takes the predetermined route, and to calculate a new average carbon emission amount to serve as a calculation basis for the next round of taking the predetermined route. Therefore, it does not take years to establish a carbon emission baseline, which can effectively shorten the time to establish the carbon emission baseline. Moreover, with respect a user who usually adopts a transport scheme of low carbon emission, the method can utilize the segmental standard carbon emissions as basis of calculation, so as to avoid underestimation of carbon credits, thereby actually capable of achieving the goals that the present invention is made for.

Further, existing personal carbon credit calculating methods commonly take comparison of a personal carbon emission amount with a standard carbon emission baseline available from public average carbon emission. For people using transport schemes of high carbon emissions, regardless how and what actions they are taking, the carbon credits obtained are always of negative values and it is virtually of no positive value, resulting in no motivation for the people to take any carbon reduction movement. Therefore, if the comparison is made with a user's personal average carbon emission baseline, then a positive value of carbon credit may be achieved, providing encouragement for further movement and making people who adopt transport schemes of high carbon emission to act for carbon reduction. On the other hand, for people who take transport schemes of low carbon emissions, if comparison is made with a user's personal average carbon emission baseline, then it occurs that there is no much positive value may be obtained for the carbon credit, and even carbon credits of negative values, and this becomes punishment that loses the motivation for further reduction of carbon emission. Therefore, for people using transport schemes of low carbon emissions, the comparison should be made with the standard carbon emission baseline, and this can effectively encourage the people to do further reduction of carbon emission. Implementing with the present invention is more in line with human nature and can effectively encourage people using both high and low carbon emission transport schemes to consistently carry out movement for carbon reduction in order to further lower down the amount of carbon emission.

I claim:

1. A method of calculating carbon credit based on personal carbon emission for a user using a portable device to calculate carbon credit saved in each round of traveling along a predetermined route, wherein the predetermined route comprises a plurality of predetermined nodes, and a route between two adjacent ones of the predetermined nodes is defined as a travel segment, wherein the portable device comprises a display panel for displaying data, a satellite positioning module for measuring a self-position, a storage module for storing data, and an operation module electrically connected with the display panel, the satellite positioning module, and the storage module, the method of calculating carbon credit based on personal carbon emission comprising the following steps:
Step S1, the user activating the portable device and starting to move along the predetermined route, such that the portable device is operable to identify predetermined nodes past thereby, to define the travel segments, and to calculate a travel distance and a carbon credit saved, wherein the storage module stores at least one predetermined traveling means carbon emission parameter corresponding to a plurality of types of traveling means data, an average carbon emission amount and every one-trip personal carbon emission amount corresponding thereto, a cumulative comparison carbon credit, and a cumulative standard carbon credit;
Step S2, passing through one of the predetermined nodes and executing at least one round of segmental carbon emission calculation operation, wherein upon passing through one of predetermined nodes, the portable device starts to perform at least one round of segmental carbon emission calculation operation, wherein each round of segmental carbon emission calculation operation comprises:
Step S2-1, executing a traveling means data and recording a travel distance toward a next one of the predetermined nodes, wherein a traveling means data is selected and executed, and the portable device calculates the travel distance toward the next one of the predetermined nodes based on measurement data of the satellite positioning module; and
Step S2-2, calculating a segmental personal carbon emission amount corresponding to the travel segment, wherein the operation module applies Formula (1) to calculate a segmental personal carbon emission amount of the user corresponding to the travel segment for storing in the storage module,
$$P {A}_{( N )} = {V}_{( X )} * {D}_{( N )} \qquad Formula ( 1 )$$
where PA is the segmental personal carbon emission amount of the user; V_{(X)} is the traveling means carbon emission parameter of the traveling means so selected; and D_{(N)} is a total travel distance within the travel segment;
Step S3, adding up all segmental personal carbon emission amounts to obtain a one-trip personal carbon emission amount corresponding to the predetermined route, wherein when the portable device reaches a last one of the predetermined nodes of the predetermined route, Formula (4) is applied to carry out calculation by adding up all of the segmental personal carbon emission amounts that are calculated in Step S2-2 of each round performed for the predetermined route to calculate a one-trip personal carbon emission amount corresponding to the predetermined route and Formula (4-1) is applied to calculate an average carbon emission amount of the user for storing in the storage module,
$$TPA = {PA}_{( 1 )} + P {A}_{( 2 )} + … + P {A}_{( N )} \qquad Formula ( 4 )$$
$$ACE = {TPA}_{( 1 )} + T P {A}_{( 2 )} + … + T P {A}_{( N - 1 )} / N - 1 \qquad Formula ( 4 - 1 )$$
where TPA is the one-trip personal carbon emission amount of the entire trip, and ACE is the average carbon emission amount of the entire trip;
Step S4, calculating a one-trip carbon emission comparison amount based on the average carbon emission amount and the one-trip personal carbon emission amount, and adding the one-trip carbon emission comparison amount to a cumulative comparison carbon credit to serve as a new cumulative comparison carbon credit to be displayed on the portable device, wherein Formula (5) or Formula (6) is applied to calculate the one-trip carbon emission comparison amount based on the average carbon emission amount and the one-trip personal carbon emission amount stored in the storage module, and Formula (7) and Formula (7-1) are applied to calculate the new cumulative comparison carbon credit that is then displayed on the portable device; and
$$When ACE > TPA , CTA = ACE - TPA \qquad Formula ( 5 )$$
$$When ACE \leq TPA , CTA = 0 or = ACE - TPA \qquad Formula ( 6 )$$
$$and ACC = SUM ( {CTA}_{( 1 )} : CT {A}_{( N )} ) \qquad Formula ( 7 )$$
$$NACC = SUM [ {( CTA + A C C )}_{( 1 )} : {( CTA + ACC )}_{( N )} ] \qquad Formula ( 7 - 1 )$$
where ACE is the average carbon emission amount; TPA is the one-trip personal carbon emission amount; CTA is the one-trip carbon emission comparison amount; ACC is the cumulative comparison carbon credit; and NACC is the new cumulative comparison carbon credit;
Step S5, subjecting the average carbon emission amount and all of the one-trip personal carbon emission amounts corresponding thereof to an averaging operation with the one-trip personal carbon emission amount of this round to update to a new average carbon emission amount, wherein the portable device subjects the average carbon emission amount and all of the one-trip personal carbon emission amounts corresponding thereto to operation of Formula (8) to update to a new average carbon emission amount to be stored in the storage module,
$$NACE = SUM ( {TPA}_{( 1 )} : TP {A}_{( N )} ) / N \qquad Formula ( 8 )$$
where NACE is the new average carbon emission amount.

2. The method of calculating carbon credit based on personal carbon emission according to claim 1, wherein in Step S4, the calculation of the one-trip carbon emission comparison amount is as follows:
$$when ACE \leq TPA , CTA = 0.$$

3. The method of calculating carbon credit based on personal carbon emission according to claim 1, wherein in Step S2, each round of segmental carbon emission calculation operation further comprises Step S2-3, and in Step S2-3, a segmental standard carbon emission amount corresponding to the travel segment is calculated, wherein the portable device applies Formula (2) to calculate the segmental standard carbon emission amount corresponding to the travel segment,
$$S {A}_{( N )} = {V}_{( X ) L} * {D}_{( N )} \qquad Formula ( 2 )$$
$$TSA = {SA}_{( 1 )} + S {A}_{( 2 )} + … + S {A}_{( N )} \qquad Formula ( 3 )$$
where SA is the segmental standard carbon emission amount; V_{(X)L} is the lowest traveling means carbon emission parameter among the predetermined traveling means; D_{(N)} is the travel distance; and TSA is the one-trip standard carbon emission amount of the entire trip;
wherein the method of calculating carbon credit based on personal carbon emission further comprises Step S6 and Step S7;
In Step S6, a segmental standard carbon emission difference amount corresponding to the travel segment is obtained by subtracting, from each of the segmental standard carbon emission amounts, the segmental personal carbon emission amount corresponding thereto, wherein when the portable device reaches the last one of the predetermined nodes of the predetermined route, Formula (9) is applied to calculate the segmental standard carbon emission difference amount corresponding to the travel segment based on each round of Step S2-3,
$$S A {D}_{( N )} = S {A}_{( N )} - {PA}_{( N )} \qquad Formula ( 9 )$$
where SAD_{(N)} is the segmental standard carbon emission difference amount; SA_{(N)} is the segmental standard carbon emission amount obtained in Formula (2); and PA_{(N)} is the segmental personal carbon emission amount obtained in Formula (1); and
In Step S7, positive ones of the segmental standard carbon emission difference amounts are added, wherein the portable device adds up the positive ones of the segmental standard carbon emission difference amounts to be stored in the storage module.

4. The method of calculating carbon credit based on personal carbon emission according to claim 3, wherein the storage module further stores a cumulative standard carbon credit, and in Step S7, the positive ones of the segmental standard carbon emission difference amounts and the cumulative standard carbon credit are added together to form a new cumulative standard carbon credit to be then displayed on the portable device, wherein the portable device subjects the positive ones of the segmental standard carbon emission difference amounts to calculation of Formula (10) to form the new cumulative standard carbon credit NZ to be then displayed on the portable device, and stores the new cumulative standard carbon credit NZ again in the storage module to serve as a next cumulative standard carbon credit,
$$w hen {SAD}_{( N )} > 0 , N Z = S A {D}_{( N )} + Z \qquad Formula ( 10 )$$
where NZ is the new cumulative standard carbon credit, and Z is the cumulative standard carbon credit.

5. The method of calculating carbon credit based on personal carbon emission according to claim 1, wherein the storage module stores a predetermined traveling means carbon emission parameter corresponding to a different speed of each type of the traveling means data, and in Step S2-1, the operation module is operable to calculate an average traveling speed according to the measurement data of the satellite positioning module, and in Step S2-2, the operation module uses the recorded traveling means data and the predetermined traveling means carbon emission parameter corresponding to the average traveling speed to calculate the segmental personal carbon emission amount.

6. The method of calculating carbon credit based on personal carbon emission according to claim 1, wherein the display panel of the portable device comprises one of a mobile phone screen, a smart watch screen, and screens of other portable display devices
